(19) United States
(12) Patent Application Publication
(10) Pub. No.: US 2013/0055373 A1
(43) Pub. Date: Feb. 28, 2013

(54) PROTOCOL RATE FILTERING AT EDGE DEVICE

(71) Applicants: Gordon B. Beacham, San Diego, CA (US); Tim J. Stephens, San Diego, CA (US)

(72) Inventors: Gordon B. Beacham, San Diego, CA (US); Tim J. Stephens, San Diego, CA (US)

(73) Assignee: GENERAL INSTRUMENT CORPORATION, Horsham, PA (US)

(21) Appl. No.: 13/218,004

(22) Filed: Aug. 25, 2011

(51) Int. Cl. G06F 21/20

(52) U.S. Cl. 726/13

(57) ABSTRACT

A method includes configuring a plurality of rate filters for a plurality of protocols. The plurality of rate filters are associated with a plurality of rate thresholds for the plurality of protocols. An edge device receives a packet for a flow. The packet is received from a customer premise equipment device for sending through an egress interface of the edge device. A rate of packets being sent for the flow and a protocol in the plurality of protocols associated with the packet are determined A rate filter in the plurality of rate filters that is associated with the determined protocol is determined where the rate filter is associated with a rate threshold in the plurality of rate thresholds. The method determines an event is occurring when the rate of packets exceeds the rate threshold associated with the determined rate filter and performs an action to mitigate the event.

### BACKGROUND

Particular embodiments generally relate to network management.

Denial of Service (DoS) attacks are an attempt to make a computer resource unavailable to its intended users. For example, the attack may prevent an Internet site or service from functioning efficiently or at all. A target machine may be saturated with external communication requests such that it cannot respond to legitimate traffic or responds in a slow enough manner as to be rendered almost unavailable.

Some solutions exist for preventing and responding to Denial of Service attacks. Generally, these solutions assume that the Denial of Service attack is coming from the Internet. In one case, a cable modem termination system (CMTS) may be used to detect a high rate of address resolution protocol (ARP) packets that are being sent. The ARP packets are for resolution of network layer addresses into link layer addresses during Internet transmissions. This solution, however, only analyzes ARP packets. Also, the CMTS is typically located at a head end of a network operator's network. Attempting to prevent the Denial of Service attack at the CMTS allows traffic into an access network all the way to the CMTS, which exposes part of a network provider's network.

In cable networks, a cable operator has conventionally been limited to using the Data Over Cable Service Interface Specification (DOCSIS) standards-compliant filtering schemes that are shown below in Table I for filtering Internet Protocol packets by port and IP addresses.

TABLE I

docsDevFilterIpStatus
docsDevFilterIpControl
docsDevFilterIpIfIndex
docsDevFilterIpDirection
docsDevFilterIpBroadcast
docsDevFilterIpSaddr
docsDevFilterIpSmask
docsDevFilterIpDaddr
docsDevFilterIpDmask
docsDevFilterIpProtocol
docsDevFilterIpSourcePortLow
docsDevFilterIpSourcePortHigh
docsDevFilterIpDestPortLow
docsDevFilterIpDestPortHigh
docsDevFilterIpMatches
docsDevFilterIpTos
docsDevFilterIpTosMask
docsDevFilterIpContinue
docsDevFilterIpPolicyId

The filters in Table I may be used by a cable modem at the edge of the home network and the access network. However, the filtering is only applied by port or IP address, which is not adequate to detect devices, such as “bots” in a “botnet” that are initiating DoS attacks on the access network from home networks.

### SUMMARY

In one embodiment, a method includes configuring a plurality of rate filters for a plurality of protocols. The plurality of rate filters are associated with a plurality of rate thresholds for the plurality of protocols. An edge device receives a packet for a flow. The packet is received from a customer premise equipment device for sending through an egress interface of the edge device. A rate of packets being sent for the flow and a protocol in the plurality of protocols associated with the packet are determined A rate filter in the plurality of rate filters that is associated with the determined protocol is determined where the rate filter is associated with a rate threshold in the plurality of rate thresholds. The method determines an event is occurring when the rate of packets exceeds the rate threshold associated with the determined rate filter and performs an action to mitigate the event.

In one embodiment, an apparatus including one or more computer processors and a computer-readable storage medium is provided. The computer-readable storage medium includes instructions operable to: configure a plurality of rate filters for a plurality of protocols, wherein the plurality of rate filters are associated with a plurality of rate thresholds for the plurality of protocols; receive a packet for a flow, the packet being received from a customer premise equipment device for sending through an egress interface of the apparatus; determine a rate of packets being sent for the flow; determine a protocol in the plurality of protocols, the determined protocol being associated with the packet; determine a rate filter in the plurality of rate filters that is associated with the determined protocol, the rate filter being associated with a rate threshold in the plurality of rate thresholds; determine an event is occurring when the rate of packets exceeds the rate threshold associated with the determined rate filter; and perform an action to mitigate the event.

In one embodiment, a non-transitory computer-readable storage medium contains instructions for controlling a computer system to be operable to: configure a plurality of rate filters for a plurality of protocols, wherein the plurality of rate filters are associated with a plurality of rate thresholds for the plurality of protocols; receive a packet for a flow, the packet being received from a customer premise equipment device for sending through an egress interface of an edge device; determine a rate of packets being sent for the flow; determine a protocol in the plurality of protocols, the determined protocol being associated with the packet; determine a rate filter in the plurality of rate filters that is associated with the determined protocol, the rate filter being associated with a rate threshold in the plurality of rate thresholds; determine an event is occurring when the rate of packets exceeds the rate threshold associated with the determined rate filter; and perform an action to mitigate the event.

The following detailed description and accompanying drawings provide a more detailed understanding of the nature and advantages of the present invention.

### BRIEF DESCRIPTION OF THE DRAWINGS

FIG. 1 depicts a system for performing protocol rate filtering according to one embodiment.

FIG. 2 depicts an example of a security manager according to one embodiment.

FIG. 3 depicts an example of a filter table according to one embodiment.

FIG. 4 depicts a simplified flowchart for applying filters to packets sent on an egress interface according to one embodiment.

FIG. 5 depicts a simplified flowchart for dynamically changing a threshold according to one embodiment.

FIG. 6 depicts a simplified flowchart for adjusting a threshold based on a home network profile for a home network according to one embodiment.

FIG. 7 depicts a simplified flowchart for a method for identifying the source and troubleshooting the event according to one embodiment.

### DETAILED DESCRIPTION

Described herein are techniques for a rate filtering system at an edge device. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

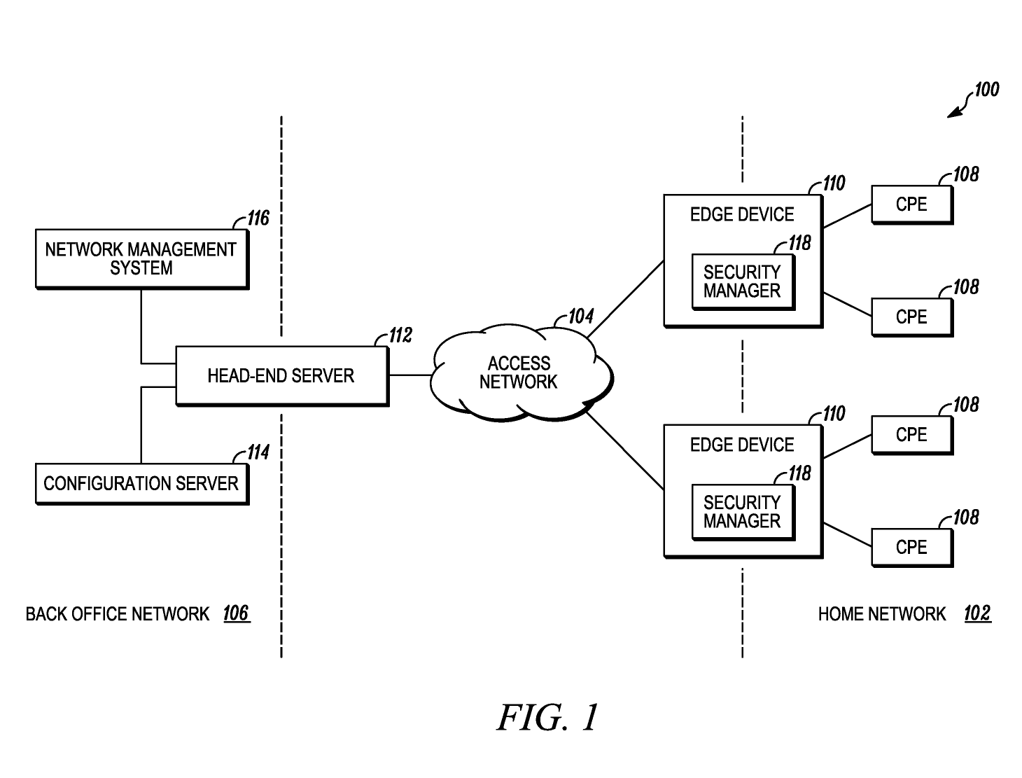

FIG. 1 depicts a system 100 for performing protocol rate filtering according to one embodiment. System 100 includes a home network 102, an access network 104, and a back office network 106. Home network 102 may be a local area network (LAN) located in a user's home. Although the term “home” is used, home network 102 may be any local network coupled to access network 104. For example, home network 102 may be a local area network (LAN) for an enterprise. Home network 102 includes customer premise equipment (CPE) 108, which may include various computing devices, such as personal computers, set top boxes, cellular phones, tablet devices, and other computing devices. CPEs 108 may communicate with an edge device 110 to download and upload data.

Edge device 110 may be situated on the edge of access network 104. Examples of edge device 110 include a cable modem (CM) or a digital subscriber line (DSL) gateway. Edge device 110 is a bridge between home network 104 and access network 104. Different types of access networks 104 may be used, such as a hybrid fiber co-ax network, a wireless network, a wired network, etc.

A head end server 112 may be located at a network operator's head end location and communicates packets from edge device 110 to a wide area network (not shown). Additionally, head end server 112 may be coupled to a configuration server 114 and a network management system (NMS) 116 through a back-office network 106. Configuration server 114 may be used to send configuration files to edge device 110. As will be discussed in more detail below, a configuration file may include a list of protocols and thresholds that are used for rate filtering. Network management system 116 may be used to manage alerts and other mitigating actions that should be performed when thresholds are violated as will be described later.

Edge device 110 includes a security manager 118. Security manager 118 monitors packets being sent from CPE 108 through an egress interface to access network 104. Security manager 118 determines the protocol associated with the packet and then determines the rate of packets being sent on the egress interface during a specific time interval. If the number of packets sent during the interval exceeds a threshold configured for the protocol, security manager 118 generates an event and then takes an action to mitigate the event. For example, security manager 118 may throttle the packet rate to an acceptable configured limit by filtering packets being sent on the egress interface. Additionally, an alert may be sent using a network management protocol to NMS system 116. The event may then be further analyzed to determine if the event is associated with an attack, such as a denial of service (DoS) attack or other malevolent behavior.

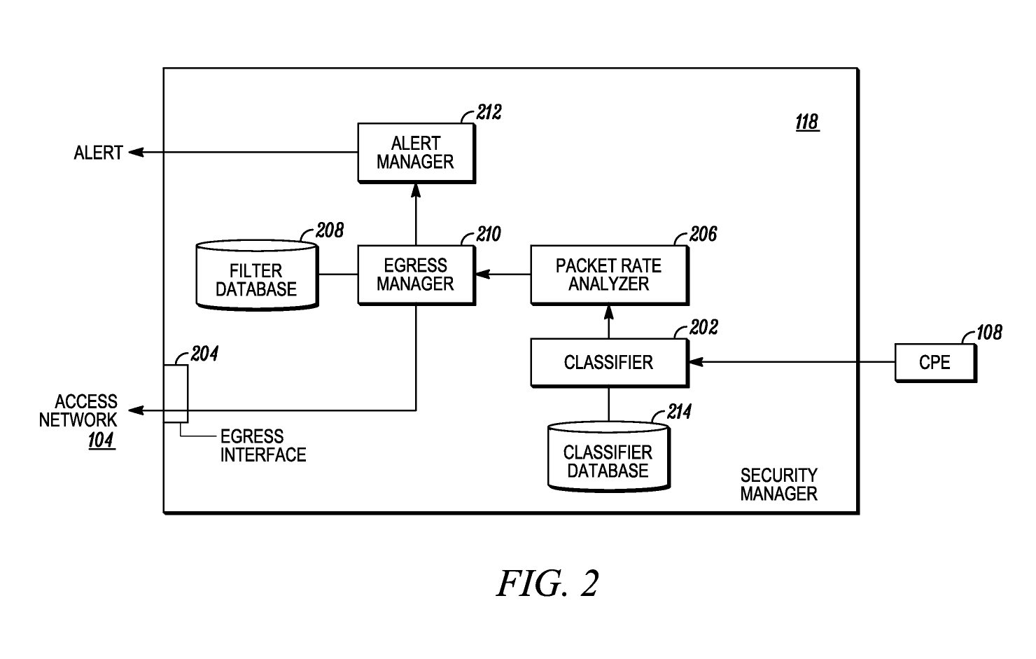

FIG. 2 depicts a more detailed example of security manager 118 according to one embodiment. A classifier 202 receives packets from CPE 108. Classifier 202 uses a classifier database 214 to match packets and assign the packets to flows. A flow may be a sequence of packets from a source to a destination. The flow may also include packets from multiple sources to multiple destinations. Classifier database 214 includes information that defines the flows. Packets may be matched to a flow by a field in a packet, such as protocol, source address, and destination address fields. The packets are sent through an egress interface 204 to access network 104. These packets are sent through head end server 112 to a wide area network (WAN).

Different types of packets may be sent through egress interface 204. For example, different protocols may be used. Different protocols may be associated with different rates that may be deemed acceptable. For example, the number of packets sent for different protocols that may be considered acceptable may vary. Thus, depending on the protocol being used, different thresholds are used.

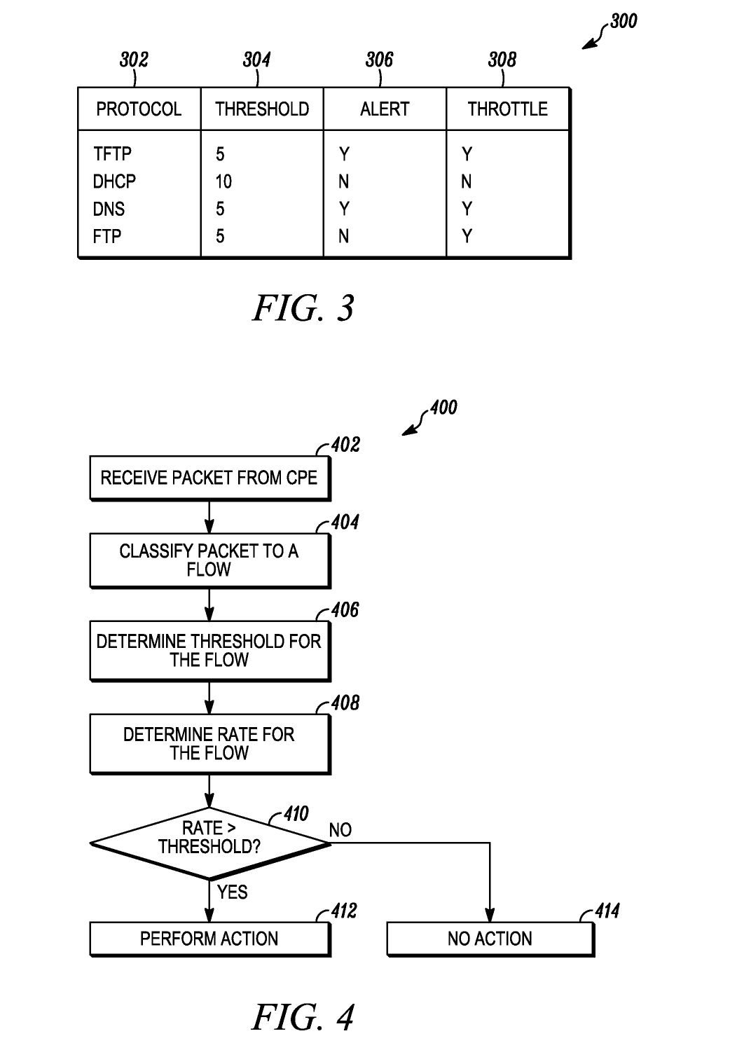

The protocols and associated thresholds may be stored as “filters” in a filter database 208. The filters may specify the protocol and threshold. In one embodiment, configuration server 114 may upload a configuration file to edge device 110. Edge device 110 would then install the filters in filter database 208. FIG. 3 depicts an example of a filter table 300 according to one embodiment. In a column 302, different protocols are shown. For example, protocols include trivial file transfer protocol (TFTP), dynamic host configuration protocol (DHCP), domain name system (DNS), and file transfer protocol (FTP). Other protocols may also be used.

A column 304 shows different thresholds for the protocols. A threshold is a limit that is used to determine when a potential event may be occurring, such as an attack. Different thresholds may be used because different rates for different protocols may be considered as potential attacks. For example, the TFTP, DNS, and FTP protocols have a threshold of 5 and the DHCP protocol includes a threshold of 10. By allowing the configuration of different thresholds for different protocols, a finer granularity to detecting when possible events may be occurring is provided. For example, if a universal threshold of 5 is used, there is a potential that more false positives for attacks using the DHCP protocol may be detected because rates under the threshold of 10 are considered acceptable for the DHCP protocol.

A column 306 indicates whether an alert should be sent. For example, an alert may be sent to an operator that indicates a potential event occurred at edge device 110. Also, a user of CPE 108 may be alerted. Not all protocols may generate alerts, however. As will be discussed below, a mitigating action (e.g., filtering of packets) may just be taken instead of providing an alert.

A column 308 indicates whether a packet should be throttled. For example, the mitigating action may drop the packet if throttling is indicated for the protocol.

Referring back to FIG. 2, a packet rate analyzer 206 determines a rate for the packets being sent. For example, packet rate analyzer 206 may count the number of packets being sent on egress interface 204 during a time interval.

An egress manager 210 determines the applicable filter from filter database 208 based on the flow. For example, the protocol being used to send packets for the flow is used to determine the applicable filter. The protocol may be determined using known methods, such as by inspecting fields of the packet to determine the protocol. Once the protocol is determined, Egress manager 210 then compares the rate with the threshold associated with the filter for the protocol. For example, if TFTP is being used, then the threshold of “5” is determined If the rate exceeds the threshold, then an event is determined.

Egress manager 210 may take an action to mitigate the event. For example, egress manager 210 may throttle the packet being sent through egress interface 204. The throttling of multiple packets for a flow may bring the rate of packets being sent through egress interface 204 to an acceptable level, such as a level below the threshold. For example, for each packet analyzed while the rate is above a threshold, egress manager 210 may drop the packet. Additionally, egress manager 210 may trigger an alert to be sent by an alert manager 212. The alert may be sent depending on the value in column 306 of table 300. For example, for some protocols, alerts may not need to be sent and throttling is just performed. An alert may be sent using simple network management protocol (SNMP), which is a protocol for managing devices on networks. Other protocols may also be used, such as TR-69, and SYSLOG.

The alert may be sent to network management system 116, which may take different actions. For example, an operator may be alerted of the event. Also, a trouble ticket may be generated to have an operator check edge device 110 to determine if the problem has occurred. The alert may also be sent to a user of home network 102.

The event indicates that the threshold has been violated and a possible attack may be occurring. Not all violations may be considered attacks, however. An analysis may be performed to determine if the event is an attack. For example, egress manager 210 may analyze the event to determine if an attack is occurring. Additionally, network management system 116 may analyze information in the alert to see if an attack is occurring. Various known algorithms may be used to analyze if the event is an attack. During the analysis, particular embodiments may throttle the rate of packets being sent. In other embodiments, the rate of packets being sent may not be throttled until it is determined whether an attack is occurring.

FIG. 4 depicts a simplified flowchart 400 for applying filters to packets sent on egress interface 204 according to one embodiment. At 402, classifier 202 receives a packet. The packet is being sent in the egress direction through egress interface 204. At 404, classifier 202 classifies the packet to a flow. In one example, fields of the packet may be matched to a flow, which is associated with a protocol.

At 406, egress manager 210 determines the threshold for the flow. For example, a protocol associated with the flow is looked up in table 300. The threshold associated with that protocol is determined At 408, packet rate analyzer 206 determines a rate for the flow. For example, a counter may be used to count the number of packets being sent over a period of time for the flow. The period of time may be pre-configured or vary based on the protocol being used.

At 410, egress manager 210 determines if the rate is greater than the threshold for the flow. If not, at 414, no action is taken. The process may continue monitoring the packets being sent.

If the rate is greater than the threshold, at 412, egress manager 210 performs an action. As discussed above, egress manager 210 may drop the packet. Packets for the flow may continue to be dropped until the number of packets being sent is below a threshold. Also, an alert may be generated.

Another action that may be performed is a dynamic change of the threshold in response to the event. The threshold may be changed after an analysis of the event. For example, if a potential attack is determined and after analysis, the event is not considered an attack, then the threshold may be set too low.

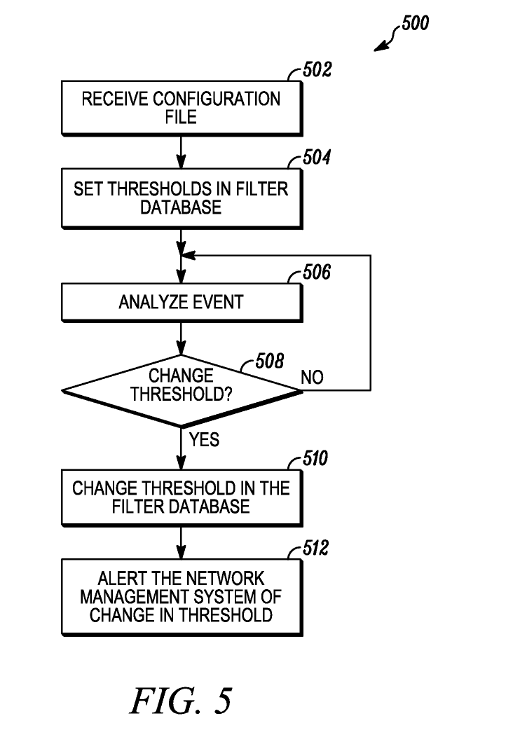

FIG. 5 depicts a simplified flowchart 500 for dynamically changing a threshold according to one embodiment. At 502, security manager 118 receives a configuration file. The configuration file may include different filters that include the protocols and thresholds. These may be baseline thresholds. At 504, the thresholds are installed in table 300 in filter database 208.

At 506, an event is analyzed. For example, an entity (egress manager 210, network management system 116, or another entity) analyzes the event to determine if it is associated with an attack or is legitimate activity. In this case, an application may analyze characteristics of the event to determine if the event is associated with a known attack. For example, different information such as the source of the packets (CPE 108), the rate of the packets, and other information about home network 102 may be used to determine if the event is associated with an attack.

In some cases, if events are being detected and are not determined to be associated with attacks (e.g., false positives), then the threshold being used may not be ideal. At 508, it is determined if the threshold should be changed. The threshold may be changed based on one false positive or it may take a series of false positives to change cause the threshold to be changed. If not, the process reiterates to 506 to analyze any other events that occur. If the threshold should be changed, then at 510, the threshold is changed in filter database 208. The level of change may be based on the analysis. For example, the threshold is adjusted to a level of the rate that was detected. Other increases may be used, such as gradual increases by certain increments. By dynamically changing the threshold, more robust event detection is provided. The detection of events may be more efficient and fewer false positives may result.

In addition to the change in threshold, at 512, alert manager 212 may optionally communicate with network management system 116 to alert the operator of the change in the threshold. The change may be reviewed to determine if the new threshold should be distributed to other edge devices 110. If so, configuration server 114 sends a new configuration file with the change in threshold. Upon receiving the new configuration file, each edge device 110 may then install the new threshold in table 300.

In another example, the threshold may be adjusted based on a profile of usage in home network 102. Because edge device 110 is coupled to CPEs 108 in home network 102, network traffic in home network 102 may be analyzed and used to determine appropriate thresholds. For example, different home networks 102 may be used differently and result in different levels of usage. In one example, some entities may have usage patterns that have higher rates of packets sent, but these higher rates may not be considered attacks. Thresholds may thus be customized to the usage in different home networks 102.

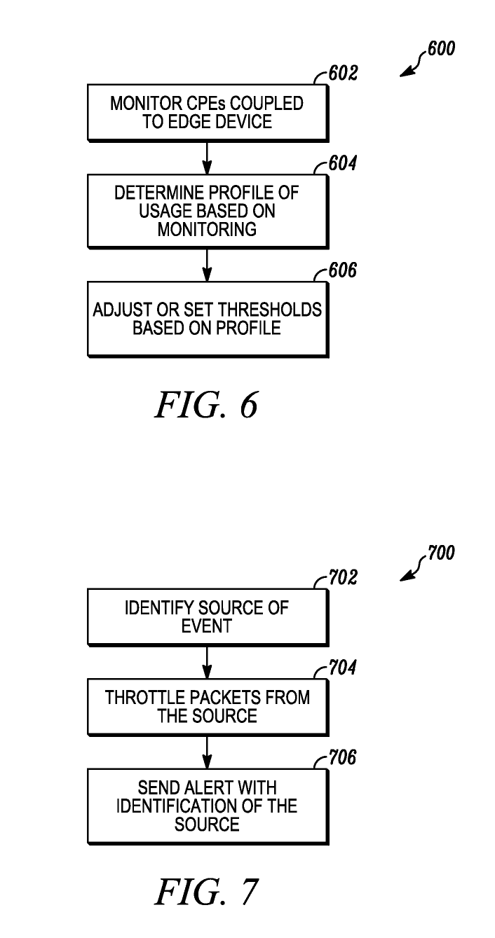

FIG. 6 depicts a simplified flowchart 600 for adjusting a threshold based on a home network profile for home network 102 according to one embodiment. At 602, edge device 110 monitors CPEs 108 that are coupled to edge device 110 in home network 102. The monitoring may determine the rates for packets being sent from different CPEs 108 over a period of time. In one example, the rates may be classified per CPE 108 or may be averaged for all CPEs 108 in home network 102.

At 604, edge device 110 determines a profile of usage for home network 102 based on the monitoring. This profile may characterize the rate of packets being sent. Also, the profile may include the time of day where the rates apply. For example, a user may be uploading data during certain times in a day. At other times, the usage may be lower. Higher thresholds may be configured for times when the usage is higher.

At 606, edge device 110 adjusts thresholds in table 300 based on the profile. For example, certain thresholds in the baseline thresholds received from configuration server 114 may be adjusted based on the profile. This may provide better detection of irregular activity on home network 102. For example, a user may be legitimately sending packets at a rate that is above the baseline thresholds. If the thresholds are not adjusted, the user may constantly have the packets being sent throttled. By adjusting the threshold higher, spikes in usage from a higher baseline may be detected and the number of false positives may be reduced.

An additional advantage of using edge device 110 to detect the rate of packets being sent on egress interface 204 is that edge device 110 can identify the source of the packets being sent in home network 102. The source may then be used in troubleshooting the event. FIG. 7 depicts a simplified flowchart 700 for a method for identifying the source and troubleshooting the event according to one embodiment. At 702, edge device 110 identifies a source of an event. For example, edge device 110 may analyze the packets being sent to identify a CPE 108 that is sending the packets. Other information may also be gathered from CPE 108. For example, CPE 108 may be pinged to determine a current status of the device.

At 704, egress manager 210 may throttle packets only from that source. For example, packets being sent by other CPEs 108 may not be throttled. Thus, only the performance of the suspected CPE 108 is affected. This allows a user to continue to use other CPEs 108 without any throttling.

At 706, alert manager 212 may send an alert with the identification of the source along with any other source-related information. For example, the alert may include an identifier for a CPE 108. Including the identification may allow the troubleshooting of the problem in a more efficient manner. For example, a trouble ticket may be created for a representative of the network operator to analyze the CPE 108 that caused the event. Additionally, an alert may be sent notifying the user of a potential problem with CPE 108 that triggered the event.

Accordingly, particular embodiments may detect events at edge device 110. If the events are associated with attacks, such as Denial of Service attacks, then mitigating action may be performed at edge device 110. This may throttle the amount of packets entering into access network 104, which may provide additional security for a network operator as large amount of packets cannot reach access network 104. Additionally, alerts may be generated for analysis or troubleshooting.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
configuring a plurality of rate filters for a plurality of protocols, wherein the plurality of rate filters are associated with a plurality of rate thresholds for the plurality of protocols;
receiving, at an edge device, a packet for a flow, the packet being received from a customer premise equipment device for sending through an egress interface of the edge device;
determining a rate of packets being sent for the flow;
determining a protocol in the plurality of protocols, the determined protocol being associated with the packet;
determining a rate filter in the plurality of rate filters that is associated with the determined protocol, the rate filter being associated with a rate threshold in the plurality of rate thresholds;
determining an event is occurring when the rate of packets exceeds the rate threshold associated with the determined rate filter; and
performing an action to mitigate the event.

2. The method of claim 1, wherein the action comprises throttling the rate of packets being sent.

3. The method of claim 2, wherein the throttling comprises dropping the packet.

4. The method of claim 2, wherein the throttling filters a number of packets being sent through the egress interface to lower the rate of packets being sent to a defined level.

5. The method of claim 1, wherein the action comprises sending an alert including information for the event.

6. The method of claim 1, further comprising:
receiving a configuration file including the plurality of rate filters from a configuration server; and
installing the plurality of rate filters at the edge device.

7. The method of claim 1, further comprising:
analyzing the event to produce an analysis; and
changing, based on the analysis, the rate threshold for the determined protocol associated with the packet.

8. The method of claim 7, wherein the rate threshold for the determined protocol associated with the packet is changed when the event is determined to be a denial of service (DoS) attack.

9. The method of claim 1, further comprising:
monitoring the customer premise equipment device to determine a profile of usage associated with packets received from the customer premise equipment; and
determining a value for one of the plurality of rate thresholds based on the profile of usage.

10. The method of claim 1, further comprising:
identifying the customer premise equipment device as a source of the event; and
causing the action to be performed with the customer premise equipment device.

11. The method of claim 10, wherein
packets from the identified customer premise equipment device are filtered, and
packets from another customer premise equipment device are not filtered.

12. The method of claim 1, wherein different protocols in the plurality of protocols are associated with different rate thresholds in the plurality of rate thresholds.

13. The method of claim 1, wherein the edge device is situated on an edge of a home network including the customer premise equipment device and an access network.

14. An apparatus comprising:
one or more computer processors; and
a computer-readable storage medium comprising instructions for controlling the one or more computer processors to be operable to:
configure a plurality of rate filters for a plurality of protocols, wherein the plurality of rate filters are associated with a plurality of rate thresholds for the plurality of protocols;
receive a packet for a flow, the packet being received from a customer premise equipment device for sending through an egress interface of the apparatus;
determine a rate of packets being sent for the flow;
determine a protocol in the plurality of protocols, the determined protocol being associated with the packet;
determine a rate filter in the plurality of rate filters that is associated with the determined protocol, the rate filter being associated with a rate threshold in the plurality of rate thresholds;
determine an event is occurring when the rate of packets exceeds the rate threshold associated with the determined rate filter; and
perform an action to mitigate the event.

15. The apparatus of claim 14, wherein the action comprises dropping the packet.

16. The apparatus of claim 14, further operable to:
analyze the event to produce an analysis; and
change, based on the analysis, the rate threshold for the determined protocol associated with the packet.

17. The apparatus of claim 14, further operable to:
monitor the customer premise equipment device to determine a profile of usage associated with packets received from the customer premise equipment; and
determine a value for one of the plurality of rate thresholds based on the profile of usage.

18. The apparatus of claim 14, further operable to:
identify the customer premise equipment device as a source of the event; and
cause the action to be performed with the customer premise equipment device.

19. The apparatus of claim 14, wherein the apparatus is situated on an edge of a home network including the customer premise equipment device and an access network.

20. A non-transitory computer-readable storage medium containing instructions for controlling a computer system to be operable to:
configure a plurality of rate filters for a plurality of protocols, wherein the plurality of rate filters are associated with a plurality of rate thresholds for the plurality of protocols;
receive a packet for a flow, the packet being received from a customer premise equipment device for sending through an egress interface of an edge device;
determine a rate of packets being sent for the flow;
determine a protocol in the plurality of protocols, the determined protocol being associated with the packet;
determine a rate filter in the plurality of rate filters that is associated with the determined protocol, the rate filter being associated with a rate threshold in the plurality of rate thresholds;
determine an event is occurring when the rate of packets exceeds the rate threshold associated with the determined rate filter; and
perform an action to mitigate the event.
